(19) United States
(12) Patent Application Publication
(10) Pub. No.: US 2026/0269464 A1
(43) Pub. Date: Sep. 10, 2026

(54) ANTENNA WITH A COVER HAVING A GEOMETRY FOR LIQUID SHEDDING

(71) Applicant: Kymeta Corporation, Redmond, WA (US)

(72) Inventors: Curtis Bartosz, Monroe, WA (US); Jace Barley, Seattle, WA (US)

(21) Appl. No.: 19/553,081

(22) Filed: Feb. 27, 2026

Related U.S. Application Data
(60) Provisional application No. 63/768,776, filed on Mar. 7, 2025.

(51) Int. Cl. H01Q 1/42

(52) U.S. Cl. CPC H01Q 1/42

(57) ABSTRACT

An antenna with a cover having a geometry for water shedding and a satellite terminal having the same are disclosed. In some embodiments, an electronically steerable antenna with improved water shedding, includes an antenna cover having a plurality of channels to shed liquid off of the antenna cover and a plurality of geometric structures with a plurality of channels such that each channel runs between at least two geometric structures of the plurality of geometric structures. In some embodiments, each geometric structure has a base with at least one side of the base abutting one channel of the plurality of channels and having a slope to cause liquid droplets to shed into one or more of the plurality of channels.

### RELATED APPLICATION

The present application is a non-provisional application of and claims the benefit of U.S. Provisional Patent Application No. 63/768,776, filed Mar. 7, 2025, and entitled “WATER SHEDDING THROUGH COMPLEX RADOME GEOMETRY”, which is incorporated by reference in its entirety.

### FIELD OF THE DISCLOSURE

Embodiments disclosed herein are related generally to wireless communication; in particular, embodiments disclosed herein are related to an antenna cover with structures to support water shedding.

### BACKGROUND

Metasurface antennas have recently emerged as a new flat-panel antenna technology for generating steered, directive beams from a lightweight, low-cost, and planar physical platform. Such metasurface antennas have been recently used in a number of applications, such as, for example, satellite communication. Metasurface antennas may comprise radio-frequency (RF) radiating metamaterial antenna elements that can selectively couple energy from a feed wave to produce beams that may be controlled for use in communication. These antennas are capable of achieving comparable performance to phased array antennas from an inexpensive and easy-to-manufacture hardware platform.

Metasurface and other antennas include an enclosure with a surface (e.g., cover, radome, etc.). Water pooling on an antenna surface causes severe gain degradation during and after rain events. Prior solutions to keep water off the antenna surface during and after rain events have involved steep tilting of a flat surface, doming with a small radius of curvature, or application of a super hydrophobic coating. The steep tilting and doming both contribute significantly to the overall height of the product. Super hydrophobic coatings are expensive and sensitive to abrasion and contamination which leads to short field lives.

### SUMMARY

An antenna with a cover having a geometry for water shedding and a satellite terminal having the same are disclosed. In some embodiments, an electronically steerable antenna with improved water shedding, includes an antenna cover having a plurality of channels to shed liquid off of the antenna cover and a plurality of geometric structures with a plurality of channels such that each channel runs between at least two geometric structures of the plurality of geometric structures. In some embodiments, each geometric structure has a base with at least one side of the base abutting one channel of the plurality of channels and having a slope to cause liquid droplets to shed into one or more of the plurality of channels.

### BRIEF DESCRIPTION OF THE DRAWINGS

The embodiments described herein and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded isometric view of a satellite antenna according to some embodiments.

FIG. 2 illustrates a schematic view of a satellite communication system according to some embodiments.

FIG. 3 illustrates a perspective view of some embodiments of small square pyramids for water shedding.

FIG. 4 illustrates a side view of some embodiments of small square pyramids for water shedding.

FIGS. 5A-5C illustrate a perspective view, side view and pyramid close up view, respectively, of some embodiments of an antenna.

FIGS. 6A-6C illustrate a perspective view, side view and pyramid close up view, respectively, of some embodiments of an antenna.

FIGS. 7A-7C illustrate a top view and two side views of some embodiments of an antenna.

FIGS. 8A-8C illustrate portions of some embodiments of an antenna having filleted corners.

FIGS. 9A-9B illustrate a perspective view and side view of some embodiments of an antenna that includes grooves across the entire surface in one direction for water shedding.

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, in order to avoid obscuring the present disclosure.

Embodiments disclosed herein include an antenna with a surface having geometric structures that facilitate water shedding. The geometric structures have localized slopes that help shed water droplets. In some embodiments, the antenna surface comprises a radome skin (or outer radome surface) having small repeating features having localized slopes that cause small water droplets to run off the antenna surface. Such embodiments are described in more detail below.

### Examples of Antenna Embodiments

The techniques described herein may be used with a variety of satellite antennas, for example, but not limited to, flat panel satellite antennas, phased array antenna, and electronically steered antennas, etc. Some embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Pat. No. 11,489,266, entitled “Metasurface Antennas Manufactured with Mass Transfer Technologies,” issued Nov. 1, 2022. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

Although embodiments in this disclosure may draw on some examples in communications, some embodiments could be implemented in various receiving, transmitting, and/or sensing or other similar applications. Some examples could include devices for radar, lidar, sensors and sensing device such as, but not limited to, those in autonomous vehicles applications, and any other applications that can take advantage of attributes of an active metasurface according to various disclosed and undisclosed embodiments of the present disclosure.

In some embodiments, the antenna aperture having the one or more arrays of antenna elements is comprised of multiple segments that are coupled together. In some embodiments, when coupled together, the combination of the segments form groups of antenna elements (e.g., closed rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

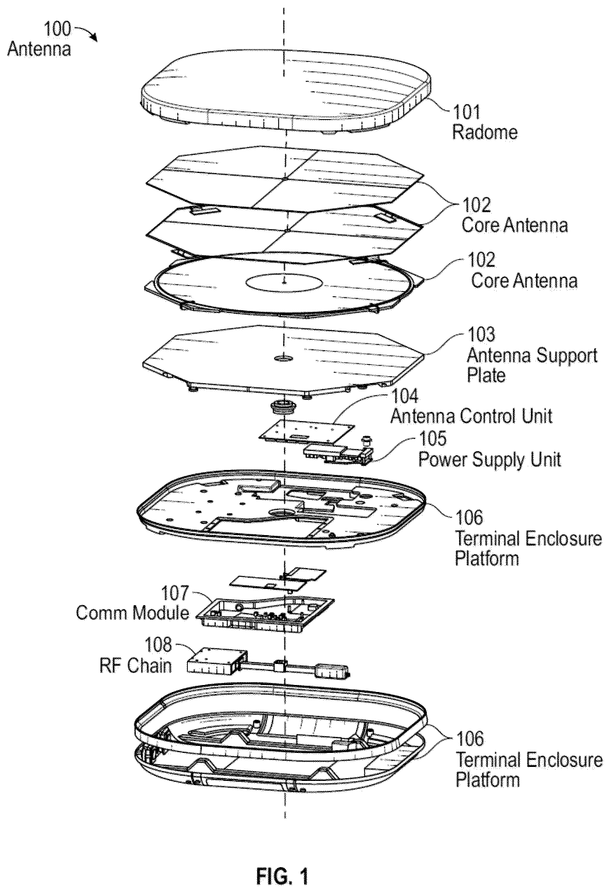

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, which are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having a unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation

$$f = \frac{1}{2 π \sqrt{LC}}$$

where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018 or in U.S. Pat. No. 11,489,266, entitled “Metasurface Antennas Manufactured with Mass Transfer Technologies,” issued Nov. 1, 2022. In some embodiments, the cylindrical wave feed feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include the one or more substrate layers forming the RF radiating antenna elements. In some embodiments, these layers may also include impedance matching layers (e.g., a wide-angle impedance matching (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100. Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

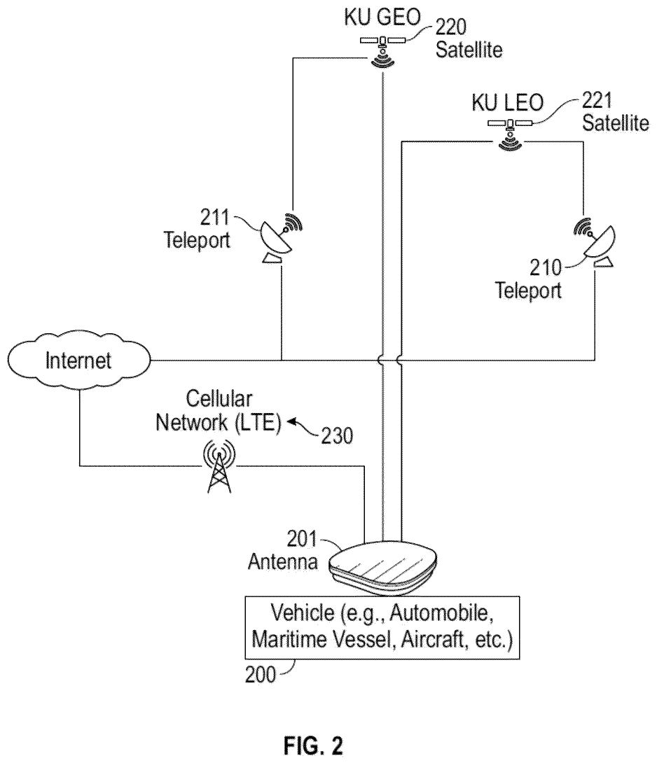

FIG. 2 illustrates an example of a communication system that includes one or more antennas described herein. Referring to FIG. 2, vehicle 200 includes an antenna 201. In some embodiments, antenna 201 comprises antenna 100 of FIG. 1. In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 is able to communicate with one or more communication infrastructures (e.g., satellite, cellular, networks (e.g., the Internet), etc.). For example, in some embodiments, antenna 201 is able to communicate with satellites 220 (e.g., a GEO satellite) and 221 (e.g., a LEO satellite), cellular network 230 (e.g., an LTE, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. Pat. No. 11,818,606, entitled “Multiple Aspects of Communication in a Diverse Communication Network”, and issued Nov. 14, 2023. Communication between a network, such as for example, the Internet and satellites 220 and 221 can be via teleports 211 and 210, respectively.

In some embodiments, to facilitate communication with various satellites, antenna 201 performs dynamic beam steering. In such a case, antenna 201 is able to dynamically change the direction of a beam that it generates to facilitate communication with different satellites. In some embodiments, antenna 201 includes multi-beam beam steering that allows antenna 201 to generate two or more beams at the same time, thereby enabling antenna 201 to communicate with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221.

Thus, the antennas described herein may be part of a satellite terminal that enables ubiquitous communications and multiple different communication connections. In some embodiments, antenna 201 comprises a metasurface RF antenna having multiple RF radiating antenna elements that are tuned to desired frequencies using RF antenna element drive circuitry. The drive circuitry can include a drive transistor (e.g., a thin film transistor (TFT) (e.g., CMOS, NMOS, etc.), low or high temperature polysilicon transistor, memristor, etc.), a Microelectromechanical systems (MEMS) circuit, or other circuit for driving a voltage to an RF radiating antenna element. In some embodiments, the drive circuitry comprises an active-matrix drive. In some embodiments, the frequency of each antenna element is controlled by an applied voltage. In some embodiments, this applied voltage is also stored in each antenna element (pixel circuit) until the next voltage writing cycle.

### Antenna Surface/Radome Geometry

Embodiments disclosed herein include an antenna with a radome skin (or outer portion) having a surface geometry that enables significant improvements in water (or other liquid) shedding. In some embodiments, the antenna is a flat panel antenna. In some embodiments, the antenna (e.g., a flat panel antenna) is mounted to a device (e.g., vehicle (e.g., boat, automobile, truck, etc.) without slope. Water pooling on the antenna surface causes severe gain degradation during and after rain events. Embodiments disclosed herein keep a significant area of the antenna aperture free of water to dramatically reduce the level of gain degradation.

While prior art radome designs have had flat or gently curved surfaces, embodiments of the radome skin disclosed herein have small repeating features (structures) which enable steep localized slopes. In some embodiments, these features cover the top of the antenna aperture. In some other embodiments, these features cover only a portion (e.g., a central portion) of the antenna aperture. These steep localized slopes cause small water droplets to run into channels where they accumulate into larger drops which run off the surface at lower slope angles. This enables more of the aperture to remain free of water during and after rain events, limiting the impact to antenna performance.

The small repeating structures provide steep localized slopes. This can be in a variety of forms, one of which is a square pyramid shape. By using small repeating versions of these structures, the steep localized slopes effectively shed water during and after rain events without having to tilt the entire system, which creates unwanted height impacts. By having these structures, the antenna can maintain low profile, flat mount, and water shedding all at once.

When using the repeating structures with steep localized angles, the radome skin can enable use of materials or coatings with only moderate hydrophobicity (e.g., coatings that increase the water contact angle with the surface up to ~90-103°), which are much cheaper and more durable, while keeping the system mounted flat and low profile. Water will still shed off the aperture because the small water droplets will shed off the steep surfaces and accumulate inside the channels. In some embodiments, once the droplets accumulate into larger drops or pools of water, they shed at much lower angles (1°-4°). Since it is often difficult to mount something completely flat, there is usually a global tilt to the antenna system of about 1°-4°

In some embodiments, the radome skin includes small repeating square pyramid shapes on a flat radome surface to generate a 15° slope to shed small water droplets. In some other embodiments, the slope of the repeating square pyramid shapes on a flat radome is different than 15° and is at least 12° and going up to beyond 15°.

In some embodiments, the height of the individual pyramids or water shedding structures is 1 cm. However, the height of the individual pyramids or water shedding structures is not limited to 1 cm and can be greater or less than 1 cm. In some embodiments, the thickness of the antenna's radome with the pyramids totals 1.5 to 2 cm. Pyramids of other heights can be used up to a height above which the antenna's performance is impacted. The limit to pyramid size can be dependent on manufacturing and antenna size constraints. A taller pyramid would lead to higher incident angle and would lead water into the channels faster.

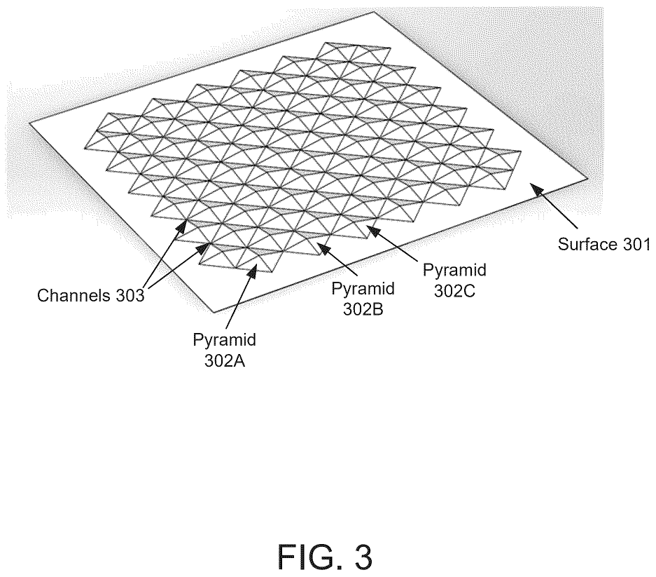

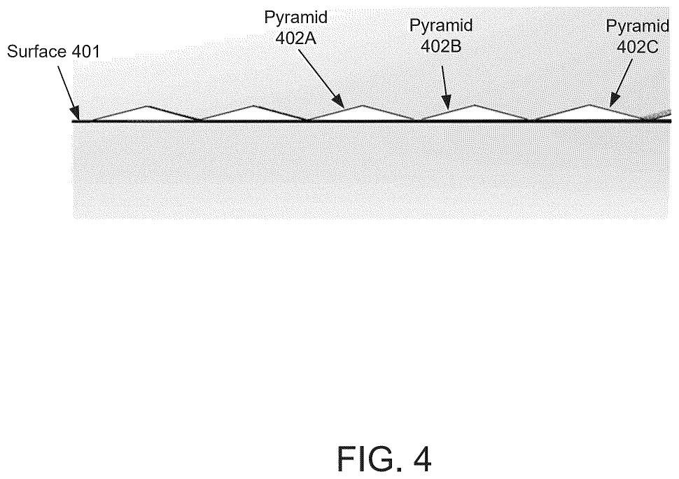

FIG. 3 is a perspective view of some embodiments of a surface with small square pyramids. Such a surface can be part of a radome or other antenna cover. Referring to FIG. 3, surface 301 includes pyramids, such as, for example, pyramids 302A-C. Each of pyramids includes a square-shaped bottom. In some embodiments, one of the bottoms of the pyramids in adjacent rows of pyramids abut or face each other forming a channel therebetween, such as, for example, channels 303. FIG. 4 is a side view of some embodiments of small square pyramids. Referring to FIG. 4, surface 401 includes pyramids, such as pyramids 402A-C.

In some embodiments, the repeating pattern of pyramids has a predetermined slope (e.g., 12°). The pyramid base can be varied. For example, two examples discussed below have a pyramid base that is approximately 84×84 mm and approximately 52×52 mm. However, the pyramid base can have other dimensions. Furthermore, the pyramid bases on the radome of an antenna need not be all the same size. For example, pyramid structures in one part of the radome (e.g., a central or inner portion of the radome) can have one size while those outside or surrounding that portion (e.g., outside or surrounding the central portion, along the outer edges of the radome, etc.) can have a different size. For example, in some embodiments, the two-thirds of radome located in the central portion of the radome surface has pyramid structures of one size with the outer one-third of the radome having pyramid structures of a different size (e.g., smaller than the pyramid structures in the central portion of the radome). However, those portions having larger pyramid structures can be larger or smaller than two-thirds of the radome. In some other embodiments, pyramid structures with different size bases are located throughout the radome skin or other antenna cover.

In some embodiments, the pyramid slope is maintained while the height of the pyramid structures changes. This can result in increasing or decreasing the number of pyramids structures.

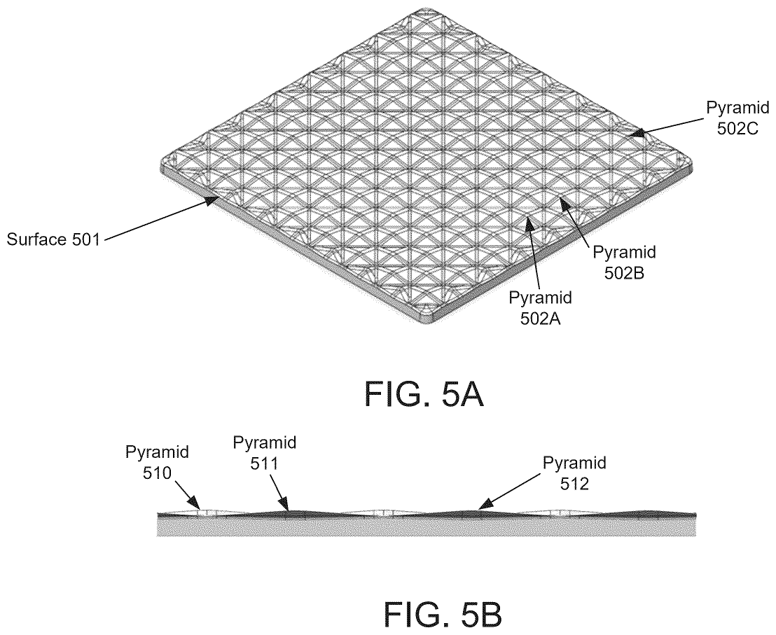

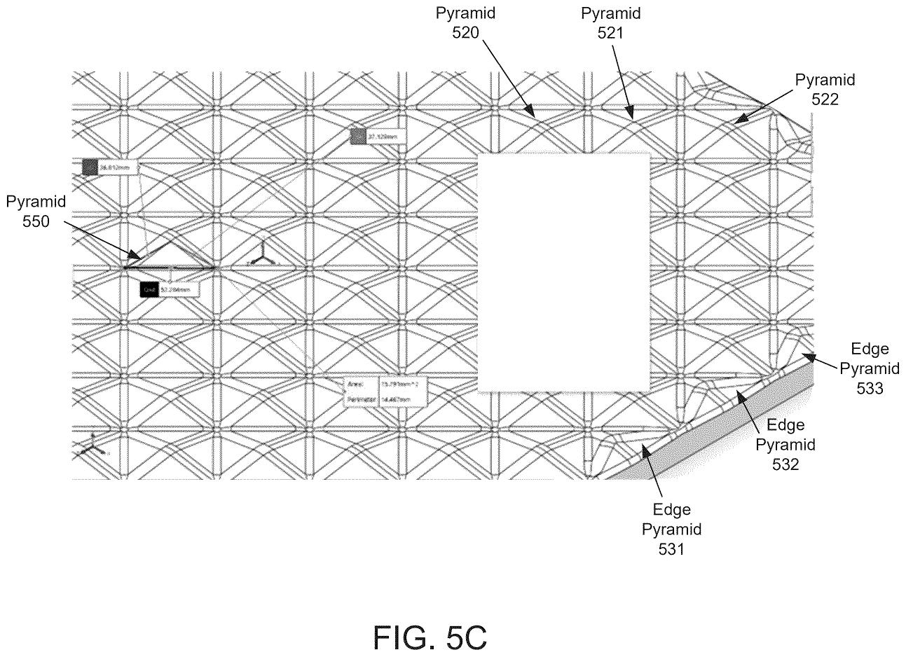

FIGS. 5A-5C illustrate a perspective view, side view and a close-up view, respectively, of some embodiments of an antenna. Referring to FIG. 5A, the antenna is square shaped and includes a surface 501 (e.g., radome) with pyramid structures, such as, for example, pyramids 502A-502C. In some embodiments, the pyramids have a square-shaped base (e.g., a 53 mm×53 mm base, etc.) and cover the top except those pyramids that run along the edge of the antenna which have a triangular bottom. Note that the techniques disclosed herein are not limited to square-shaped antennas, and the antennas can be other shapes (e.g., rectangular-shaped antennas).

FIG. 5B shows surface 501 with side views of some of the pyramid structures such as pyramids 510-512. FIG. 5C shows a close-up view of some of the pyramid structures on surface 501. In some embodiments, the pyramid structures, such as, for example, pyramids 520-522, in the interior of the antenna have square-shaped bottoms while those along pyramids on the edge or border of the antenna, such as edge pyramids 531-533 have triangular-shaped bottoms.

In some embodiments, the dimensions of a triangular portion of pyramid's interior, such as for pyramid 550, are shown with a base of 52.284 mm and sides of 36.812 mm and 37.128 mm. With these dimensions, the triangular portion has a 15° slope.

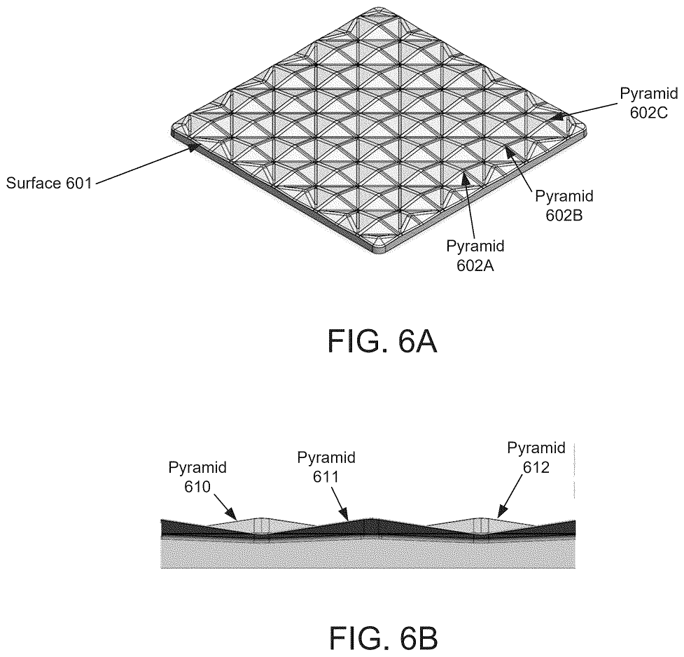

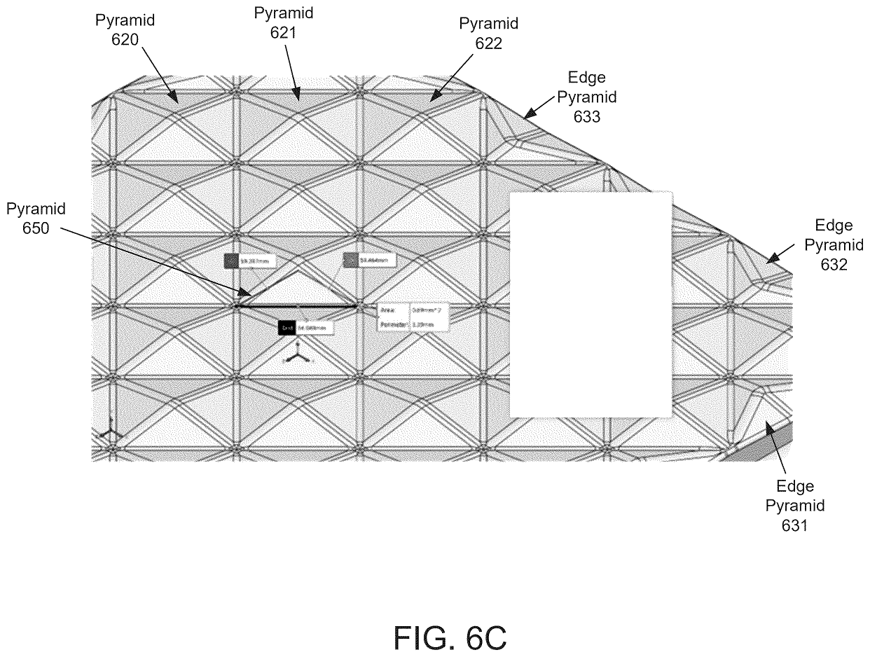

FIGS. 6A-6C illustrate a perspective view, side view and pyramid close up view, respectively, of some other embodiments of an antenna. In this case, the pyramids have an 84 mm×84 mm base. Referring to FIG. 6A, the antenna is square shaped and includes a surface 601 (e.g., radome) with pyramid structures, such as, for example, pyramids 602A-602C. In some embodiments, the pyramids cover the entire top antenna cover (e.g., radome) surface except those pyramids that run along the edge of the antenna which have a triangular, or three-sided, bottom. Note that the techniques disclosed herein are not limited to square-shaped antennas, and the antennas can be other shapes (e.g., rectangular-shaped antennas).

FIG. 6B shows surface 601 with side views of some of the pyramid structures such as pyramids 610-612. FIG. 6C shows a close-up view of some of the pyramid structures on surface 601. In some embodiments, the pyramid structures, such as, for example, pyramids 620-622, in the interior of the antenna have square-shaped bottoms while those along pyramids on the edge or border of the antenna, such as edge pyramids 631-633 have triangular-shaped bottoms.

In some embodiments, the dimensions of a triangular portion of pyramid's interior, such as pyramid 650, are shown with a base of 84.048 mm and sides of 59.39 mm and 59.464 mm. With these dimensions, the triangular portion has a 15° slope.

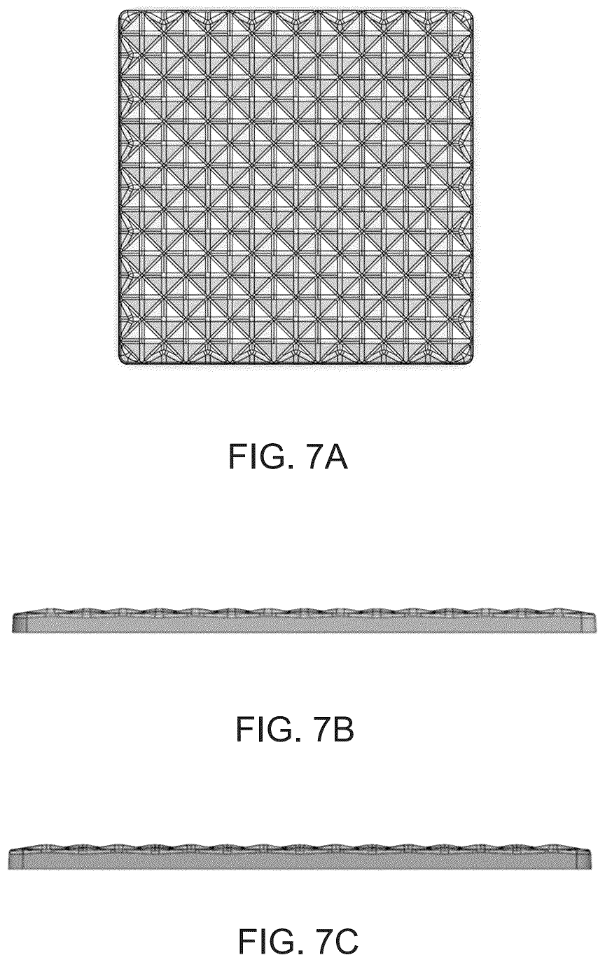

FIGS. 7A-7C above illustrates a top view and two side views of some embodiments of an antenna. In some embodiments, the pyramids in FIGS. 7A-7C have an 84 mm×84 mm base.

In some embodiments, the edge features outside of the main 4-sided pyramids in the antennas are cosmetic in nature, intended to ensure that the radome does not transition from the pyramids to ‘flat’ sections, and doesn't impact the water-shedding performance of the design.

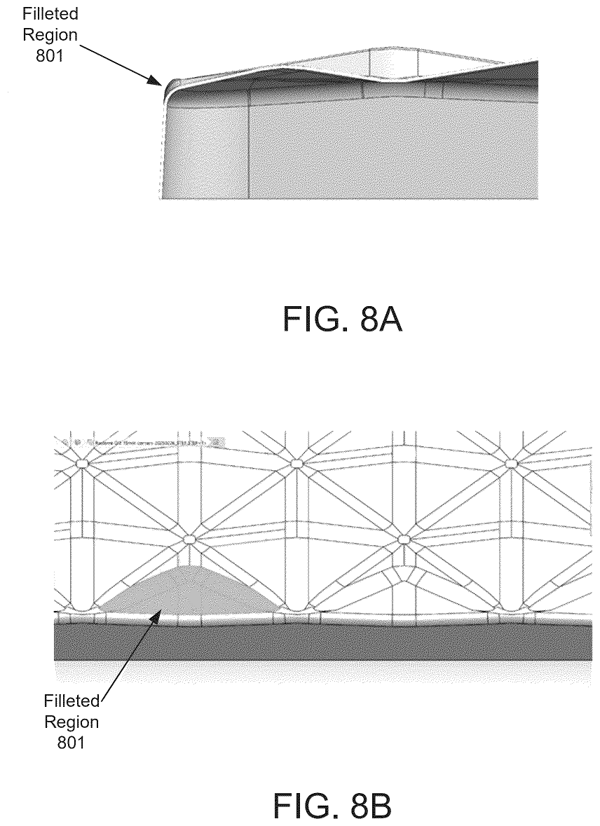

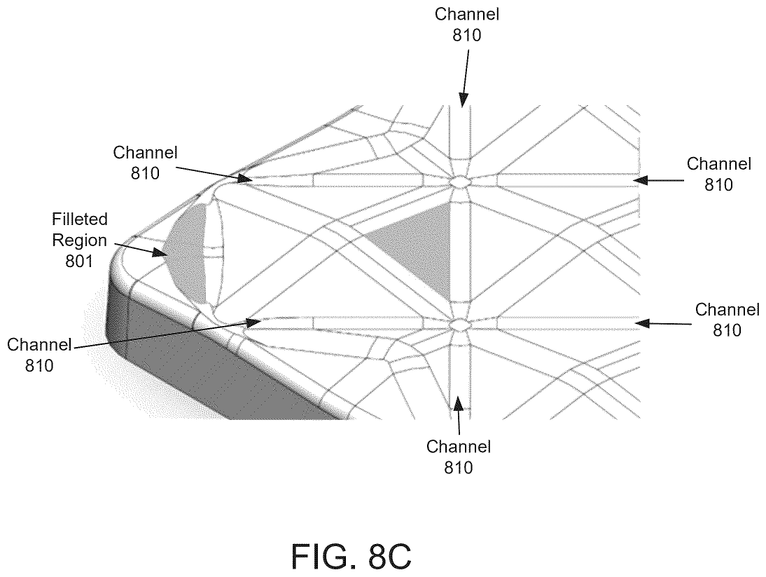

In some embodiments, the exterior feature is a continuation of the 4-sided pyramid pattern, but ‘cut short’ and then filleted to come down into the corner radii. This can be a function of the size of the component and pyramid pattern not ending cleanly at the edges. The same is true for corner sections in FIGS. 7A-7C, where the two faces that would match in the pyramid highlighted in FIGS. 8A-8C as filleted region 801. Thus, the features would be 4 sided if they could and represent a continuation of the pyramid geometry pattern. In some embodiments, they have been cut down to fit cosmetically within the confines of the antenna radome (or other antenna surface) using surface modeling techniques.

In some embodiments, the small repeating geometries with steep slopes shed small water droplets into the channels that run between them. FIG. 8C shows some example channels 810. Once water accumulates in these channels and forms larger droplets, it will run off the antenna surface much easier.

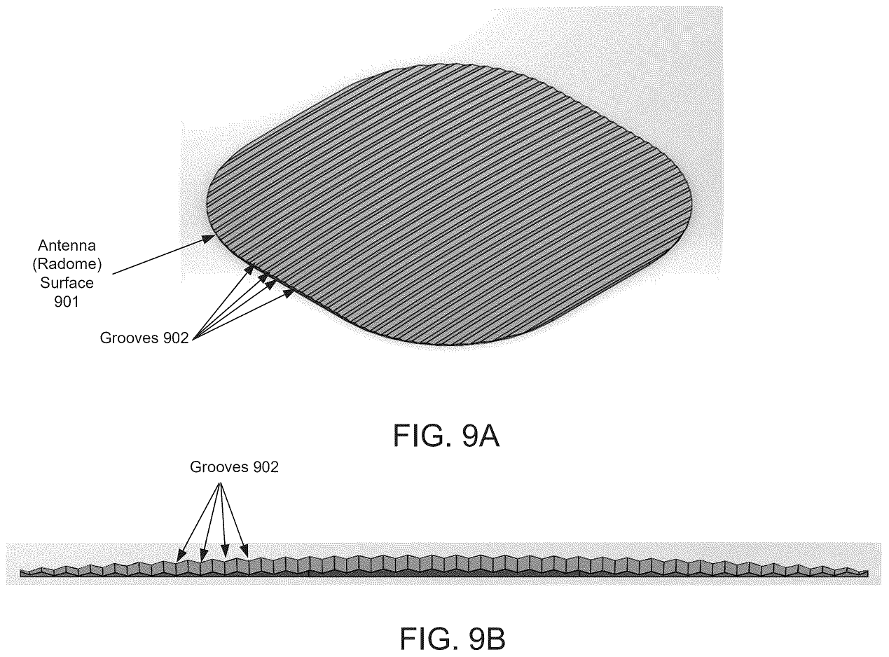

The small square pyramid design is only one option for the radome. In some alternative embodiments, any repeating structure with steep localized angles in alternating directions can create a similar water shedding effect. For example, in some embodiments, the antenna surface has grooves created across the entire surface in one direction to have a similar impact on water shedding. FIGS. 9A and 9B illustrate some embodiments of an antenna having a surface with linear grooves. Referring to FIGS. 9A and 9B, an antenna surface 901, such as a radome, includes grooves 902, that run across its entire surface area. In some other embodiments, some of the grooves do not extend across the entire surface and feed into other grooves that are able to channel water off antenna surface 901. Additionally, in some other embodiments, the groves radiate out from the center of the radome.

In some other alternative embodiments, the antenna surface has geometric structures that include repeating, rounded dome structures.

There are a number of example embodiments described herein.

Example 1 is an electronically steerable antenna with improved water shedding, the antenna comprising: an antenna cover having a plurality of channels to shed liquid off of the antenna cover and a plurality of geometric structures with a plurality of channels such that each channel runs between at least two geometric structures of the plurality of geometric structures. Each geometric structure has a base with at least one side of the base abutting one channel of the plurality of channels and having a slope to cause liquid droplets to shed into one or more of the plurality of channels.

Example 2 is the antenna of example 1 that may optionally include that the antenna cover comprises a radome skin.

Example 3 is the antenna of example 1 that may optionally include that the plurality of geometric structures includes repeating structures of a same size.

Example 4 is the antenna of example 1 that may optionally include that the plurality of geometric structures includes repeating pyramid structures.

Example 5 is the antenna of example 4 that may optionally include that each of the repeating pyramid structures has four sides defining a square base.

Example 6 is the antenna of example 5 that may optionally include a plurality of three-sided pyramid structures located at edges of the antenna cover. Each three-sided pyramid structure of the three-sided pyramid structures being adjacent to two four-sided pyramid structures.

Example 7 is the antenna of example 1 that may optionally include that the slope is at least 12 degrees from a top of each pyramid of the repeating pyramid structures to its pyramid base.

Example 8 is the antenna of example 1 that may optionally include that the slope is 15 degrees from a top of each pyramid to its base.

Example 9 is the antenna of example 1 that may optionally include that a subset of geometric structures of the plurality of geometric structures are filleted to transition down to a corner radii at edges of the antenna cover.

Example 10 is the antenna of example 1 that may optionally include that the liquid droplets accumulate in the plurality of channels that run off the antenna cover surface.

Example 11 is the antenna of example 1 that may optionally include that the plurality of geometric structures includes repeating, rounded dome structures.

Example 12 is a satellite terminal comprising an electronically steerable antenna having an antenna cover. The antenna cover has a plurality of channels to shed liquid off of the antenna cover; and a plurality of geometric structures with a plurality of channels such that each channel runs between at least two geometric structures of the plurality of geometric structures. Each geometric structure has a base with at least one side of the base abutting one channel of the plurality of channels and having a slope to cause liquid droplets to shed into one or more of the plurality of channels.

Example 13 is the antenna of example 12 that may optionally include that the antenna cover comprises a radome skin.

Example 14 is the antenna of example 12 that may optionally include that the plurality of geometric structures includes repeating structures of a same size.

Example 15 is the antenna of example 12 that may optionally include that the plurality of geometric structures include repeating pyramid structures.

Example 16 is the antenna of example 15 that may optionally include that each of the pyramid structures has four sides defining a square base. The antenna cover further comprises a plurality of three-sided pyramid structures located at edges of the antenna cover. Each three-sided pyramid structure of the three-sided pyramid structures is adjacent to two four-sided pyramid structures.

Example 17 is the antenna of example 12 that may optionally include that the slope is at least 12 degrees from a top of each pyramid of the repeating pyramid structures to its pyramid base.

Example 18 is the antenna of example 12 that may optionally include that the slope is 15 degrees from a top of each pyramid to its base.

Example 19 is the antenna of example 12 that may optionally include that a subset of geometric structures of the plurality of geometric structures are filleted to transition down to a corner radii at edges of the antenna cover.

Example 20 is the antenna of example 12 that may optionally include that the liquid droplets accumulate in the plurality of channels that run off the antenna cover surface.

Methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the functions described. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. An electronically steerable antenna with improved water shedding, the antenna comprising:
an antenna cover having
a plurality of channels to shed liquid off of the antenna cover; and
a plurality of geometric structures with a plurality of channels such that each channel runs between at least two geometric structures of the plurality of geometric structures, each geometric structure having a base with at least one side of the base abutting one channel of the plurality of channels and having a slope to cause liquid droplets to shed into one or more of the plurality of channels.

2. The antenna of claim 1 wherein the antenna cover comprises a radome skin.

3. The antenna of claim 1 wherein the plurality of geometric structures includes repeating structures of a same size.

4. The antenna of claim 1 wherein the plurality of geometric structures includes repeating pyramid structures.

5. The antenna of claim 4 wherein each of the repeating pyramid structures has four sides defining a square base.

6. The antenna of claim 5 further comprising a plurality of three-sided pyramid structures located at edges of the antenna cover, each three-sided pyramid structure of the three-sided pyramid structures being adjacent to two four-sided pyramid structures.

7. The antenna of claim 1 wherein the slope is at least 12 degrees from a top of each pyramid of the repeating pyramid structures to its pyramid base.

8. The antenna of claim 1 wherein the slope is 15 degrees from a top of each pyramid to its base.

9. The antenna of claim 1 wherein a subset of geometric structures of the plurality of geometric structures are filleted to transition down to a corner radii at edges of the antenna cover.

10. The antenna of claim 1 wherein the liquid droplets accumulate in the plurality of channels that run off the antenna cover surface.

11. The antenna of claim 1 wherein the plurality of geometric structures includes repeating, rounded dome structures.

12. A satellite terminal comprising:
an electronically steerable antenna having an antenna cover having
a plurality of channels to shed liquid off of the antenna cover; and
a plurality of geometric structures with a plurality of channels such that each channel runs between at least two geometric structures of the plurality of geometric structures, each geometric structure having a base with at least one side of the base abutting one channel of the plurality of channels and having a slope to cause liquid droplets to shed into one or more of the plurality of channels.

13. The satellite terminal of claim 12 wherein the antenna cover comprises a radome skin.

14. The satellite terminal of claim 12 wherein the plurality of geometric structures includes repeating structures of a same size.

15. The satellite terminal of claim 12 wherein the plurality of geometric structures include repeating pyramid structures.

16. The satellite terminal of claim 15 wherein each of the pyramid structures has four sides defining a square base, and
the antenna cover further comprising a plurality of three-sided pyramid structures located at edges of the antenna cover, each three-sided pyramid structure of the three-sided pyramid structures being adjacent to two four-sided pyramid structures.

17. The satellite terminal of claim 12 wherein the slope is at least 12 degrees from a top of each pyramid of the repeating pyramid structures to its pyramid base.

18. The satellite terminal of claim 12 wherein the slope is 15 degrees from a top of each pyramid to its base.

19. The satellite terminal of claim 12 wherein a subset of geometric structures of the plurality of geometric structures are filleted to transition down to a corner radii at edges of the antenna cover.

20. The satellite terminal of claim 12 wherein the liquid droplets accumulate in the plurality of channels that run off the antenna cover surface.
